(19) United States
(12) Patent Application Publication
(10) Pub. No.: US 2006/0054567 A1
(43) Pub. Date: Mar. 16, 2006

(54) System for sanitizing a spa

(76) Inventor: Charles Mousseau, Chestermere (CA)

Correspondence Address: SEAN W. GOODWIN, 237- 8TH AVE. S.E., SUITE 360, THE BURNS BUILDING, CALGARY, AB, T2G 5C3, CA

(21) Appl. No.: 10/941,888

(22) Filed: Sep. 16, 2004

(51) Int. Cl. C02F 1/50

(52) U.S. Cl. 210/748; 210/753; 210/759; 210/169; 210/192

(57) ABSTRACT

A system and method for maintaining adequate sanitizing of a spa or whirlpool, particularly those having volumes of about 200 to about 400 gallons of water, utilizes an electrolytic generator to provide sufficient chlorine or bromine during periods of low-to-no use. During periods of peak use, a buffered oxidizer is added to the spa water, either before use or immediately after use or both, to assist in removing organics and setting a pH in the spa which is conducive to maintaining adequate levels of active free chlorine or bromine to handle the increased organic load.

### FIELD OF THE INVENTION

Embodiments of the invention relate to systems for treatment of water in swimming pools, spas and the like and more particularly to sanitizing relatively small volume spas for residential use.

### BACKGROUND OF THE INVENTION

Halogens such as chlorine and bromine have long been used to sanitize water. The chemistry is well known to those skilled in the art. Hypochlorous or hypobromous acid are typically the most effective species or active free halide for sanitizing purposes. Dissociation of these acids to the less effective hypochlorite or hypobromite is pH and temperature dependant. For example, at a pH of 8.0 only about 20% hypochlorous acid is present while at a pH of about 7.5 the amount of hypochlorous acid rises to about 50-60%. Further, sunlight and organic load can also significantly affect disinfection capability.

Chlorine or bromine for sanitizing can be provided in a tablet, liquid or powdered format or can be generated on site using known electrolytic methods. Applicant is aware that electrolytic systems are commercially available which provide sufficient quantities of chlorine or bromine to effectively sanitize large volume swimming pools and the like having 15,000 to in excess of 100,000 US gallons of water. While electrolytic units have been successful in sanitizing commercial/municipal pools and spas having large volumes of water, residential spas or whirlpools having volumes of about 200 to about 400 US gallons present significant difficulties. Current electrolytic systems are not reliably controllable to produce consistent and sufficiently small volumes of halogen, particularly chlorine, to effectively sanitize without over or under-chlorination. The limited volume, high operating temperature, aeration and large organic loading or demand, when in use, combine to present challenges to keeping a constant pH and level of sanitizer.

Typically, prior art products and systems for sanitizing either provide enough chlorine to satisfy needs when the spa is not in use or enough to sanitize when it is in use and the organic load increases significantly. Applicant is not aware however, of products that are capable of effectively handling both situations.

During use, organic materials such as hair oils, body oils, sloughed skin and the like are added to the spa, causing the amount of chlorine to begin to fall as the chlorine reacts with the organics, often to levels where the chlorine level is no longer sufficient to handle the total dissolved solids and organics. In conventional spa maintenance, a periodic “shock” is required to clear or sanitize the spa. The term “shock” is typically used to refer to the addition of a high concentration of a sanitizer. Large amounts of additional chlorine or products such as OXONE® (available from Dupont® Specialty Chemicals, Wilmington, Del. 19898), a monopersulfate compound, are used to either raise the chlorine levels sufficient to sanitize the increased level of organics or to oxidize the organics through the release of oxygen. It is not recommended that the spa be used for significant periods of time following a shock treatment as the pH is typically not optimum and will result in irritation to the eyes and skin and potentially result in corrosion of metal in the spa.

Typically, shocking of the spa is performed on a scheduled basis which is determined by the spa owner when testing the water quality. As bromine and chlorine levels drop over time or are used up during peak usage periods, the user must continuously test and retest the water to determine when treatment needs to be effected. As spa usage becomes more infrequent, it becomes more difficult to adjust levels of sanitizer to meet the demands of both low usage and the sporadic higher demand. Over-chlorination during periods of low use or more frequent shocking in periods of high use may result in corrosion of metal parts within the tub.

Clearly what is required is a system for maintaining a level of sanitizer that is responsive to handle both low and high organic demand with a minimum of testing and sanitizing procedures on the part of the spa owner.

### SUMMARY OF THE INVENTION

A sanitizing method and system utilizes electrolytic generation of halide alone to sanitize spa water during periods of low-to-no use and is augmented in anticipation of or in reaction to periods of high usage and increased organic demand by the addition of a buffered oxidizer, which acts to oxidize organics, generate active free halide from salt in the spa water and to buffer the pH of the water to a range that is more favorable for maintaining a higher concentration of hypochlorous or hypobromous acid for sanitizing the increased organics. Accordingly, there is no need to maintain sanitizer levels sufficient to control organics at peak or near peak levels when the spa is not being used. The method is particularly useful for sanitizing water in spas having a volume of water of about 200 to about 400 US gallons.

In a broad aspect, a method for sanitizing water in a spa comprises: providing a halide salt in a range from about 2800 ppm to about 3500 ppm into the relatively low volume of water; and in periods of low-to-no use, exposing the relatively low volume of water to an electrolytic apparatus capable of generating a halide ion from the halide salt in the water at a pH of about 8.0 or greater, the generation of halide ion being sufficient to maintain a level of active free halide sufficient for sanitizing the relatively low volume of water during the periods of low to no organic demand; and in periods of increased organic demand, providing a buffered oxidant at about pH 7.0 to oxidize at least a portion of the organics as a result of the increased organic demand, for oxidizing the free halide to produce free active. halide and for maintaining a pH in a range from about 7.2 to about 7.8 in combination with the electrolytic apparatus so as to permit optimum levels of active free halide.

In another broad aspect, a system for sanitizing a residential spa comprises: a halide salt dissolved in a relatively low volume of water in the spa in a range of about 2500 ppm to about 3500 ppm per spa volume; an electrolytic generator for generating a halide ion from the dissolved halide salt sufficient to maintain a level of active free halide optimum for sanitizing the relatively low volume of water during periods of low-to-no organic demand and at a pH of about 8.0; and a buffered oxidizer, packaged for addition to the water for periods of high organic demand, for oxidizing at least a portion of the organics in the water, for oxidizing free halide to produce free active halide and for maintaining the pH in a range from about 7.2 to about 7.8 in combination with the electrolytic generator, so as to permit optimum levels of active free halide to be formed.

Preferably, the halide is either chloride or bromide and is electrolytically generated from sodium chloride or sodium bromide in water to produce hypochlorous acid or hypobromous acid. The pH following the electrolytic generation is approximately pH 8.0. The dissociation of hypochlorous acid to hypoclorite ion and hydrogen ion is particularly pH dependant, while the dissociation of hypobromous acid is less so. At a pH of 8.0 or higher, a smaller percentage of hypochlorous acid exists relative to hypochlorite ion, however the electrolytic generation is relied upon only during periods of very low-to-no usage of the spa and therefore, with relatively low to non-existent levels of organics present, the amount of active free chlorine (hypoclorous acid) or bromine (hypobromous acid) is sufficient to sanitize the spa.

In anticipation of, or in reaction to, increased usage of the spa and the increased organics caused therefrom, a buffered oxidizer is added to the spa to oxidize at least a portion of the organics, the pH of the buffered oxidizer being such that in combination with the pH of the electrolytic generation of halide ion being 8.0, the final pH of the spa water is in a range of pH 7.2-7.8 and preferably 7.4-7.6. At a pH of about 7.2 to about 7.8, a greater amount of hypochlorous or hypobromous acid is present and is therefore capable of sanitizing the increased organics in the spa. Further, the buffered oxidizer acts to oxidize the free halide to increase levels of active free halide.

A generator cell in the electrolytic generator is preferably small in size and capable of producing sufficient halide ion from the salt and water to maintain a free available chlorine or bromine level of between 1-5 ppm/volume with no to very low organics present in the spa water. Preferably, the free chlorine level is maintained in a range between 2.0-3.0 ppm/volume and the free bromine level is maintained in a range between 2.0-4.0 ppm/volume.

Preferably, the oxidizer is a monopersulfate such as OXONE® (pH less than or about 3.0) buffered with an alkaline salt such as sodium carbonate or sodium bicarbonate. The addition of the buffered oxidizer, having a final pH of about 7.0, to the water containing electrolytically generated halide at about pH 8.0, results in a final pH of about pH 7.4-7.6, optimum for preventing dissociation of the hypochlorous acid or hypobromous acid.

### BRIEF DESCRIPTION OF THE DRAWINGS

FIGS. 1a-c are schematic views illustrating an embodiment of the method and system of the invention for sanitizing a residential spa using a retrofit electrolytic generator and the addition of a buffered oxidizer, more particularly

FIG. 1a is a schematic illustrating sanitizing during periods of low to no usage;

FIG. 1b is a schematic illustrating sanitizing before a high organic demand; and

FIG. 1c is a schematic illustrating sanitizing after use where there is a high organic demand;

FIG. 2 is a schematic of the retrofit electrolytic generator for according to FIG. 1, for installation over a side wall of a spa; and

FIG. 3 is a sectional view of a spa wall having the electrolytic generator installed therein for use in the system according to FIGS. 1a-c.

### DETAILED DESCRIPTION OF THE PREFERRED EMBODIMENT

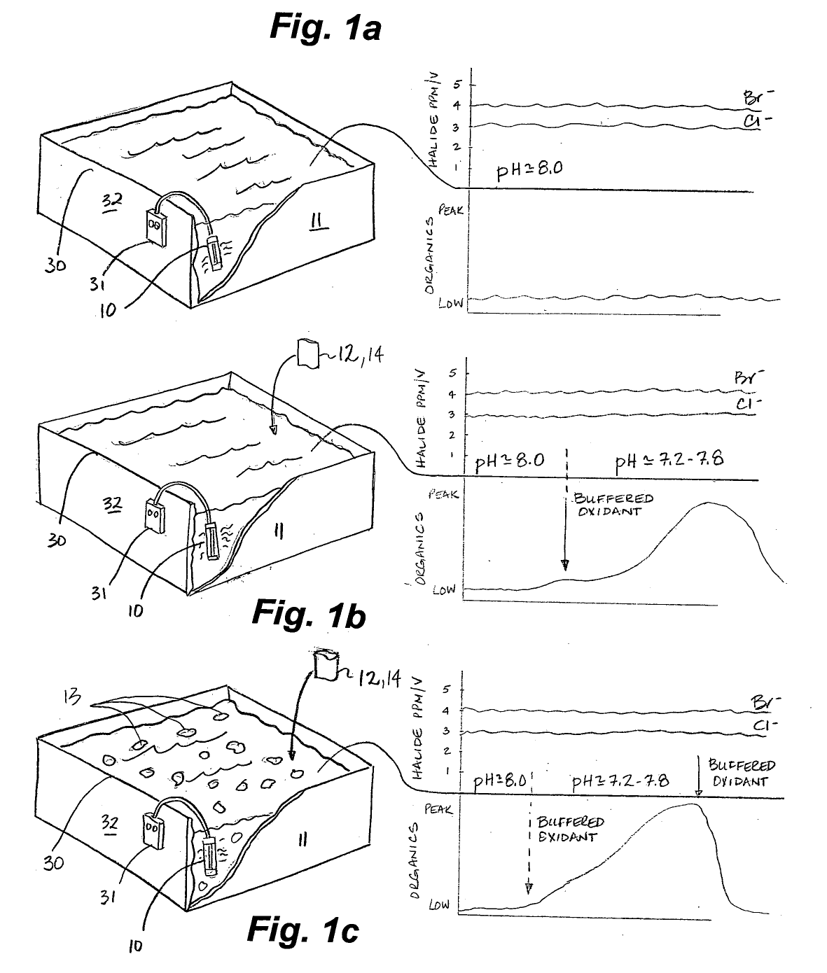

As shown in FIGS. 1a-c, and in embodiments of the invention, an electrolytic generator 10, capable of generating free active halide from a halide salt, is installed in a spa 11, such as a residential spa, having a volume of approximately 200-400 US gallons (750-1500 L) and typically supporting from 1-10 bathers at the same time. The active free halide is most effective if it is in the acid form.

Preferably, the halide is either chloride or bromide and is electrolytically generated from sodium chloride or sodium bromide in water to produce hypochlorous acid or hypobromous acid. The halide salt is added to the spa water to maintain a concentration in the range of about 2500-3500 ppm/spa volume and more preferably about 3000 ppm/spa volume. The pH following the electrolytic generation is approximately pH 8.0. The dissociation of hypochlorous acid to hypoclorite ion and hydrogen ion is particularly pH dependant, while the dissociation of hypobromous acid is less so.

During periods of low-to-no usage of the spa 11 where there is minimal organic load, the electrolytic generator is capable of providing sufficient active free halide to sanitize the spa 1. Typically, the effective range is approximately 1.0-5.0 ppm/spa volume. At a pH of 8.0 or higher, a smaller percentage of hypochlorous acid exists relative to hypochlorite ion than at lower pH, however as the electrolytic generation is relied upon only during periods of very low to no usage of the spa, the amount of active free chlorine (hypochlorous acid) or bromine (hypobromous acid) is sufficient to sanitize the spa.

As shown in FIG. 1b, in anticipation of increased usage of the spa 11 and the increased organics caused therefrom, a buffered oxidizer 12 is added to the spa 11 to oxide at least a portion of the organics, the pH of the buffered oxidizer 12 being such that in combination with the pH of the electrolytic generation of halide, the final pH of the spa water is in a range of about 7.2 to about 7.8 and preferably about 7.4 to about 7.6. At the pH of about 7.2 to about 7.8, an increased amount of chlorine or bromine, existing as hypochlorous or hypobromous acid, is present for maintaining a relatively constant level of chlorine or bromine in the water and is therefore capable of sanitizing the increased organics in the spa 11.

Further, the buffered oxidizer oxidizes the free halide present as a result of the halide salt which in turn exists as hypochlorous or hypobromous acid at a pH of about 7.2 to about 7.8. Thus, the addition of the buffered oxidizer also acts to increase the active free halide in the spa water.

Preferably, an active free chlorine level is maintained in a range between 2.0-3.0 ppm/volume and an active free bromine level is maintained in a range between 2.0-4.0 ppm/volume.

Alternatively, as shown in FIG. 1c, the buffered oxidizer 12 may be added after the spa 11 has been used and the organic load 13 has increased or the buffered oxidizer 12 can be added both immediately before and after use. In each case the levels of chlorine and bromine remain relatively consistently within the effective ranges of active free halide. Advantageously, as a result, bathers can immediately use the spa as there is no large pH shift experienced with conventional sanitizing or shocking regimes.

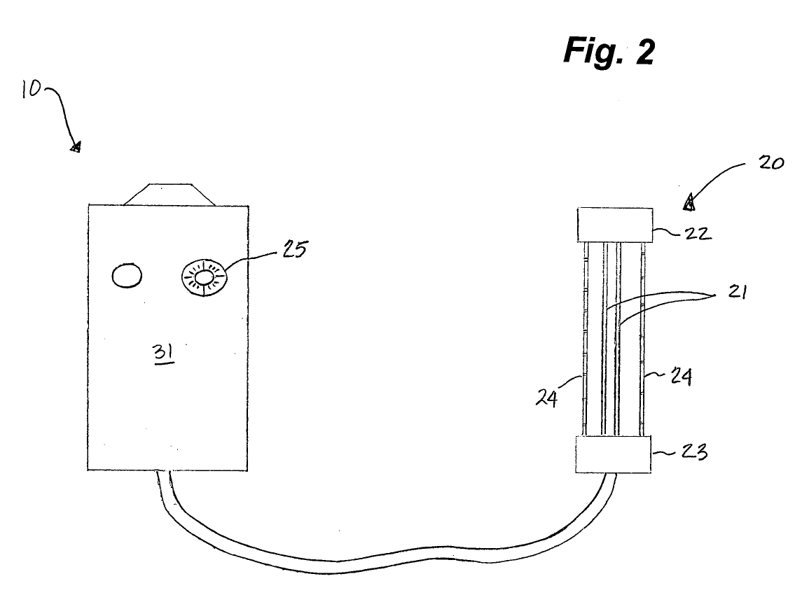

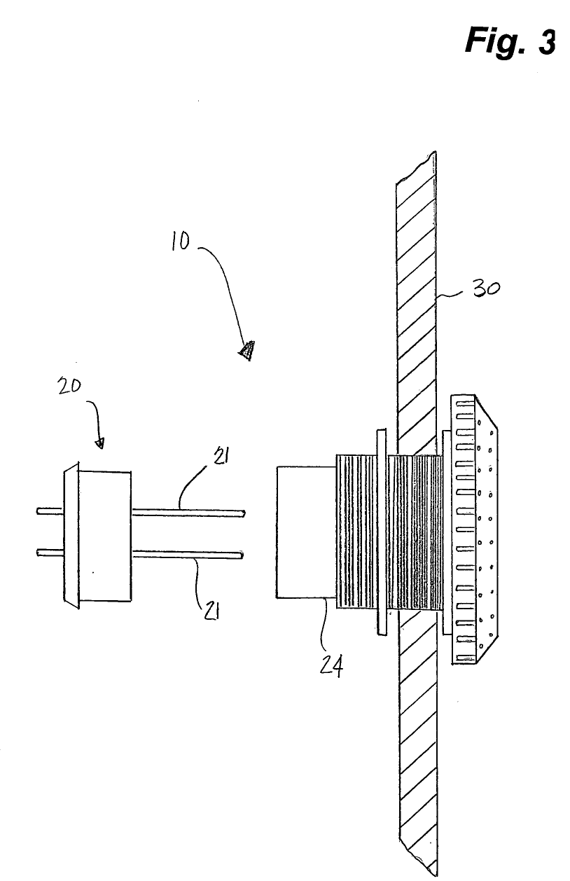

As shown in FIGS. 2 and 3, a generator cell 20 in the electrolytic generator 10 is preferably small in size and capable of producing sufficient active free halide from the salt and water to maintain the effective ranges of active free halide with no to very low organics present in the spa water. As well known to those skilled in the art, the cell 20 comprises blades 21 of a metal, such as, titanium preferably coated with a noble metal such as platinum or iridium or preferably, ruthenium. The blades 21 are sandwiched between end caps 22,23 and are housed in a perforated, transparent plastic tube 24, such as polyvinyl chloride (PVC), to protect the blades 21 from damage to the coating. The perforations in the tube 24 permit contact of the blades 21 with the water.

In an embodiment of the invention, the electrolytic generator 10 has an output control dial 25 which is manually set to control the active free halide output relative to the spa volume. Set, for example at 100%, the generator 10 is capable of producing the equivalent of approximately 15 grams of chlorine in a 24 hour period which would satisfy a spa having a volume of 400 US gal (1500 L) during periods of low-to-no use.

As shown in FIGS. 1a-c and 2, the generator 10 is available as a retrofit unit wherein the cell 20 is suspended in the water over a wall 30 of the spa 11 and a control module 31 is mounted on or adjacent an outside surface 32 of the spa 11.

Alternatively, as shown in FIG. 3, the generator 10 may be installed within the wall 30 of the spa 11 at the factory, the control module 31 being integrated into the spa controls (not shown).

Further, the generator 10 is programmed to reverse polarity at regularly scheduled intervals which assists in cleaning of the cell blades 21.

Preferably, the buffered oxidizer is a monopersulfate such as OXONE® available from Dupont® Specialty Chemicals, Wilmington, Del. 19898) (pH less than or about 3.0) buffered with an alkaline salt, such as sodium carbonate or sodium bicarbonate. The addition of the buffered oxidizer 12, having a final pH of about 7.0, to the water containing electrolytically generated halide at about pH 8.0, results in a final pH of about pH 7.4-7.6, optimum for preventing dissociation of the hypochlorous acid or hypobromous acid and maintaining a constant, reproducible level of active free halide within the spa during periods of peak usage.

Most preferably, the buffered oxidizer 12 is prepackaged in convenient pouches 14 such as a gel capsule for addition to the spa 11. One or more pouches 14 may be added depending upon the volume of the spa 11 or based on bather/organic loading.

For example in a 250 gal (1000 L) spa containing 3000 ppm sodium chloride, the addition of about 15 g of OXONE® will produce approximately 3 ppm free chlorine in demand-free water. In the presence of an organic demand, the amount of free chlorine produced will be less as a portion of the OXONE® will act to oxidize the organics.

In the case of a 250 gal (1000 L) spa containing 3000 ppm halide salt (97% sodium chloride and 3% sodium bromide), the halide will react with the OXONE® and any free chlorine will also act to oxidize bromide to bromine, Thus, virtually all of the halogen produced will be bromine. A concentration of 15 g of OXONE® will produce about 6.8 ppm of free bromine in demand-free water which is in excess of the normal amount of bromine added to a spa.

As with conventional spa maintenance regimes in spas 11 using chlorine as the active halide, cyanuric acid may be added to the spa to stabilize the chlorine, particularly if exposed directly to UV rays.

The embodiments of the invention in which an exclusive property or privilege is claimed are defined as follows:

1. A method for sanitizing water in a spa comprising:
providing about 2800 ppm to about 3500 ppm halide salt into the water; and
in periods of low-to-no use,
exposing the water to an electrolytic apparatus capable of generating a halide ion from the halide salt in the water at a pH of about 8.0, the generation of halide ion being sufficient to maintain a level of active free halide sufficient for sanitizing the relatively low volume of water during the periods of low-to-no organic demand; and
in periods of increased organic demand,
additionally adding a buffered oxidant at about pH 7.0 to oxidize at least a portion of the organics as a result of the increased organic demand, to oxidize a portion of the halide ion to generate active free halide and for maintaining a pH in a range from about 7.2 to about 7.8 in combination with the electrolytic apparatus so as to permit optimum levels of active free halide.

2. The method as described in claim 1 wherein the halide salt is sodium chloride, the halide ion is chlorine and the active free halide is hypochlorous acid.

3. The method as described in claim 1 wherein the halide salt is sodium bromide, the halide ion is bromine and the active free halide is hypobromous acid.

4. The method as described in claim 1 wherein the oxidant is potassium monopersulfate.

5. The method as described in claim 4 wherein the oxidant further comprises an alkaline salt for buffering the oxidant.

6. The method as described in claim 5 wherein the alkaline salt is sodium carbonate or sodium bicarbonate.

7. The method as described in claim 5 wherein the buffered oxidant is prepackaged for addition to the water.

8. The method as described in claim 1 wherein the electrolytic generator produces halide ion in a range from about 1 ppm to about 5 ppm per spa volume when the spa is not in use.

9. The method as described in claim 1 further comprising providing a buffered oxidant immediately before and after periods of high organic demand.

10. The method as described in claim 1 wherein the pH is maintained in a range from about 7.4 to about 7.6.

11. The method as described in claim 1 wherein the water has a volume from about 200 US gallons to about 400 US gallons.

12. A system for sanitizing water in a spa comprising:
a halide salt dissolved in the water in the spa in a range of about 2500 ppm to about 3500 ppm per spa volume;
an electrolytic generator for generating a halide ion from the dissolved halide salt sufficient to maintain a level of active free halide optimum for sanitizing the water during periods of low-to-no organic demand and at a pH of about 8.0; and
a buffered oxidizer, packaged for addition to the water for periods of high organic demand, for oxidizing at least a portion of the organics in the water, to oxidize a portion of the halide ion to generate active free halide and for maintaining the pH in a range from about 7.2 to about 7.8 in combination with the electrolytic generator, so as to permit optimum levels of active free halide to be formed.

13. The system as described in claim 12 wherein the halide salt is sodium chloride, the halide ion is chlorine and the active free halide is hypochlorous acid.

14. The system as described in claim 12 wherein the halide salt is sodium bromide, the halide ion is bromine and the active free halide is hypobromous acid.

15. The system as described in claim 12 wherein the oxidant is a monopersulfate.

16. The system as described in claim 15 wherein the oxidant further comprises an alkaline salt for buffering the oxidant.

17. The system as described in claim 16 wherein the alkaline salt is sodium carbonate or sodium bicarbonate.

18. The system as described in claim 16 wherein the buffered oxidant is prepackaged for addition to the water.

19. The system as described in claim 12 wherein the electrolytic generator produces halide ion in a range from about 1 ppm to about 5 ppm per spa volume when the spa is not in use.

20. The system as described in claim 12 further comprising providing a buffered oxidant before and after periods of high organic demand.

21. The system as described in claim 12 wherein the pH is maintained in a range from about 7.4 to about 7.6.

22. The method as described in claim 12 wherein the water has a volume from about 200 US gallons to about 400 US gallons
